(19) United States
(12) Patent Application Publication
(10) Pub. No.: US 2013/0201205 A1
(43) Pub. Date: Aug. 8, 2013

(54) METHOD OF STORING DATA, METHOD OF COMPENSATING DATA, AND DISPLAY DEVICE FOR PERFORMING THE SAME

(71) Applicant: Samsung Display Co. Ltd, Yongin-city (KR)

(72) Inventors: Sung-Gon JUNG, Suwon-si (KR); Seok-Hwan Roh, Cheonan-si (KR); Takegama Akihiro, Hwaseong-si (KR)

(73) Assignee: Samsung Display Co., Ltd, Yongin-city (KR)

(21) Appl. No.: 13/655,583

(22) Filed: Oct. 19, 2012

(30) Foreign Application Priority Data
Feb. 3, 2012 (KR) 10-2012-0011398

(51) Int. Cl. G09G 5/02

(52) U.S. Cl. 345/596

(57) ABSTRACT

An approach is provided for storing data via a processor. Reference data corresponding to an odd row of a look-up table (LUT) is stored in a first plurality of memories via the processor based on one or more grayscale values associated with a current frame and one or more grayscale values associated with a previous frame. Reference data corresponding to an even row of the LUT is stored in a second plurality of memories via the processor based on the one or more grayscale values associated with the current frame and the one or more grayscale values associated with the previous frame.

### CROSS-REFERENCE TO RELATED APPLICATION

This application claims priority from and the benefit of Korean Patent Application No. 10-2012-0011398, filed on Feb. 3, 2012, which is hereby incorporated by reference for all purposes as if fully set forth herein.

### BACKGROUND

1. Field

Exemplary embodiments of the present disclosure relate to display technology, and to a method of storing data of a look-up table, a method of compensating data, and a display device for performing the method of storing data.

2. Discussion

Generally, a display device includes a display panel and a driving part configured to drive the display panel. The driving part includes a gate driver configured to drive a gate line of the display panel, a data driver configured to drive a data line of the display panel, and a timing control part configured to provide grayscale data input from an external device to the data driver.

The timing control part is configured to provide the grayscale data to the data driver, and further configured to generate a data voltage based on the grayscale data and provide the data voltage to a pixel part of the display panel.

However, when a difference between a grayscale of a current frame and a grayscale of a previous frame is large, a response time of at least one liquid crystal of a liquid crystal layer may increase. Thus, an after image may be shown, which may blur or otherwise adversely affect the quality of the intended presentation.

Traditionally, issues associated with after images have been addressed by the timing control part being configured to provide compensated data of the grayscale data every frame. In this manner, the data driver is configured to generate a data voltage based on the compensated data and provide the data voltage to the pixel part. Thus, a liquid crystal device may compensate for slower response times of the liquid crystals via the compensated data. As such, a high quality image may be acquired.

The compensated data may be calculated (or otherwise determined) based on information stored in association with a look-up table (LUT), which may be utilized to facilitate one or more interpolations. The LUT may be stored in association with one memory or two memories configured to store reference data according to representative values of grayscale data of a previous frame and representative values of grayscale data of a current frame. The memory (or memories) is configured to output a plurality of reference data corresponding to the representative values of the grayscale data of the previous frame and the representative values of the grayscale data of the current frame according to the grayscale data of the previous frame and the grayscale data of the current frame at the same time.

Conventionally, the use of one memory or two memories to output a plurality of reference data at the same time is implemented so that the reference data may be stored redundantly. As such, a space of the memory (or memories) may be large and, thereby, increase an overall size of a display device incorporating the same.

The above information disclosed in this Background section is only for enhancement of understanding of the background of the invention and, therefore, it may contain information that does not form any part of the prior art nor what the prior art may suggest to a person of ordinary skill in the art.

### SUMMARY

Exemplary embodiments provide a method of storing data, which is capable of reducing a size of a memory part (or unit) and, thereby, avoiding unnecessary redundant storage of the data.

Exemplary embodiments provide a method of compensating data based on the data stored on (or in) the memory part associated with the method of storing the data.

Exemplary embodiments provide a display device configured to perform the method of compensating the data.

Additional aspects of the invention will be set forth in the detailed description which follows and, in part, will be apparent from the disclosure, or may be learned by practice of the invention.

According to an exemplary embodiment, a method includes: storing, in a first plurality of memories via a processor, reference data corresponding to an odd row of a look-up table (LUT) based on one or more grayscale values associated with a current frame and one or more grayscale values associated with a previous frame; and storing, in a second plurality of memories via the processor, reference data corresponding to an even row of the LUT based on the one or more grayscale values associated with the current frame and the one or more grayscale values associated with the previous frame.

According to another exemplary embodiment, a method includes: determining, via a first processor, an address of corresponding portions of a first group of memories and a second group of memories based on current grayscale data associated with a current frame and previous grayscale data associated with a previous frame, the first group of memories comprising reference data corresponding to an odd row of a look-up table (LUT) associated with the current grayscale data and the previous grayscale data, the second group of memories comprising reference data corresponding to an even row of the LUT associated with the current grayscale data and the previous grayscale data; and compensating, via the first or a second processor, the current grayscale data using the reference data associated with the address of the corresponding portions of the first group of memories and the second group of memories.

According to yet another exemplary embodiment, a display device includes: a grayscale data compensating part, including: a grayscale data converting part, a first group of memories configured to store reference data corresponding to an odd row of a look-up table (LUT) based on one or more current grayscale values associated with a current frame and one or more previous grayscale values associated with a previous frame, and a second group of memories configured to store reference data corresponding to an even row of the LUT based one or more current grayscale values associated with the current frame and one or more previous grayscale values associated with the previous frame; and a display panel configured to display an image in response to compensated grayscale data output from the grayscale data compensating part based on at least some of the reference data respectively stored in the first and second groups of memories.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a display device, according to an exemplary embodiment.

FIG. 2 is a block diagram of a grayscale data compensating part of the display device of FIG. 1, according to an exemplary embodiment.

FIG. 3 is a circuit diagram of a grayscale data converting part of the grayscale compensating part of FIG. 2, according to an exemplary embodiment.

FIG. 4 is a graph illustrating the application of dynamic capacitance compensation (DCC) to the grayscale data, according to an exemplary embodiment.

FIG. 5 is a view of various memories of the grayscale data converting part of FIG. 3, according to an exemplary embodiment.

FIG. 6 is a look-up table, according to an exemplary embodiment.

FIG. 7 is a flowchart of a process to store one or more look-up tables, according to an exemplary embodiment.

FIG. 8 is a flowchart of a process to compensate grayscale data, according to an exemplary embodiment.

FIG. 9 schematically illustrates a process to facilitate interpolation of grayscale data, according to an exemplary embodiment.

FIG. 10 is a flowchart of a process to compensate grayscale data, according to another exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. It is further noted that features and functions associated with various exemplary embodiments may be combined, separated, and/or used as alternatives or additions as would be understood by one of ordinary skill in the art. In other instances, well-known structures and devices are shown in block diagram form in order to avoid unnecessarily obscuring various exemplary embodiments.

In the accompanying figures, the size and relative sizes of layers and/or regions may be exaggerated for clarity and descriptive purposes. Also, like reference numerals denote like elements.

When an element or layer is referred to as being “on” or “connected to” another element or layer, it may be directly on or directly connected to the other element or layer, or intervening elements or layers may be present. When, however, an element is referred to as being “directly on” or “directly connected to” another element or layer, there are no intervening elements or layers present. For the purposes of this disclosure, “at least one of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by the use of these terms. These terms are only used to distinguish one element, component, region, layer or section from another element, component, region, layer or section. Thus, a first element, component, region, layer or section that is discussed below could be termed a second, third, etc., element, component, region, layer or section without departing from the teachings of the present invention.

Spatially relative terms, such as “beneath”, “below”, “lower”, “above”, “upper” and the like, may be used herein for descriptive purposes and, thereby, to describe one element or feature's relationship to another element(s) or feature(s) as illustrated in the drawings. It will be understood that spatially relative terms are intended to encompass different orientations of an apparatus in use and/or operation in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations) and, as such, the spatially relative descriptors used herein are to be interpreted accordingly.

The terminology used herein is for the purpose of describing particular embodiments only and is not intended to be limiting. As used herein, the singular forms “a”, “an” and “the” are intended to include the plural forms as well, unless the context clearly indicates otherwise. Moreover, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense unless expressly defined as such herein.

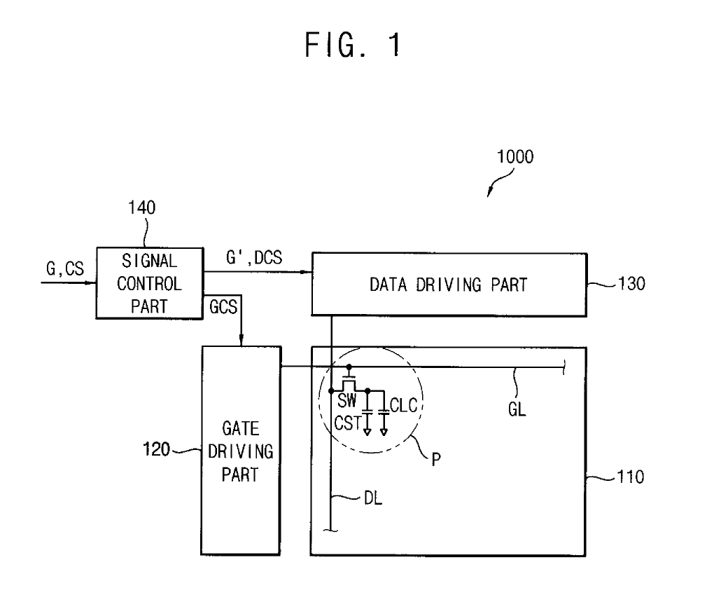

FIG. 1 is a block diagram of a display device, according to an exemplary embodiment.

Referring to FIG. 1, a display device 1000 includes a display panel 110, a gate driving part 120, a data driving part 130, and a signal control part 140. While specific reference will be made to this particular implementation, it is also contemplated that display device 1000 may embody many forms and include multiple and/or alternative components or features. For example, it is contemplated that the components of display device 1000 may be combined, located in separate structures, and/or separate locations.

According to various exemplary embodiments, the display panel 110 includes a gate line GL, a data line DL, and a pixel part P electrically connected to the gate line GL and the data line DL. The pixel part P may include a switching element SW electrically connected to the gate line GL and the data line DL. The pixel part P may further include a liquid crystal capacitor CLC and a storage capacitor CST.

The gate driving part 120 is configured to apply, to the gate line GL, at least one gate signal to activate or deactivate the gate line GL.

The data driving part 130 is configured to apply data signal(s) including a grayscale voltage to the data line DL.

The signal control part 140 is configured to receive grayscale data G and at least one control signal CS from, for example, an external device, output compensated grayscale data G′ that is compensated based on the grayscale data G, and output at least one gate control signal GCS to drive the gate driving part 120 and at least one data control signal DCS to drive the data driving part 130 based on the control signal(s) CS.

The signal control part 140 may include a grayscale data compensating part configured to apply dynamic capacitance compensation (DCC) to the grayscale data G and generate the compensated grayscale data G′ based on the DCC application.

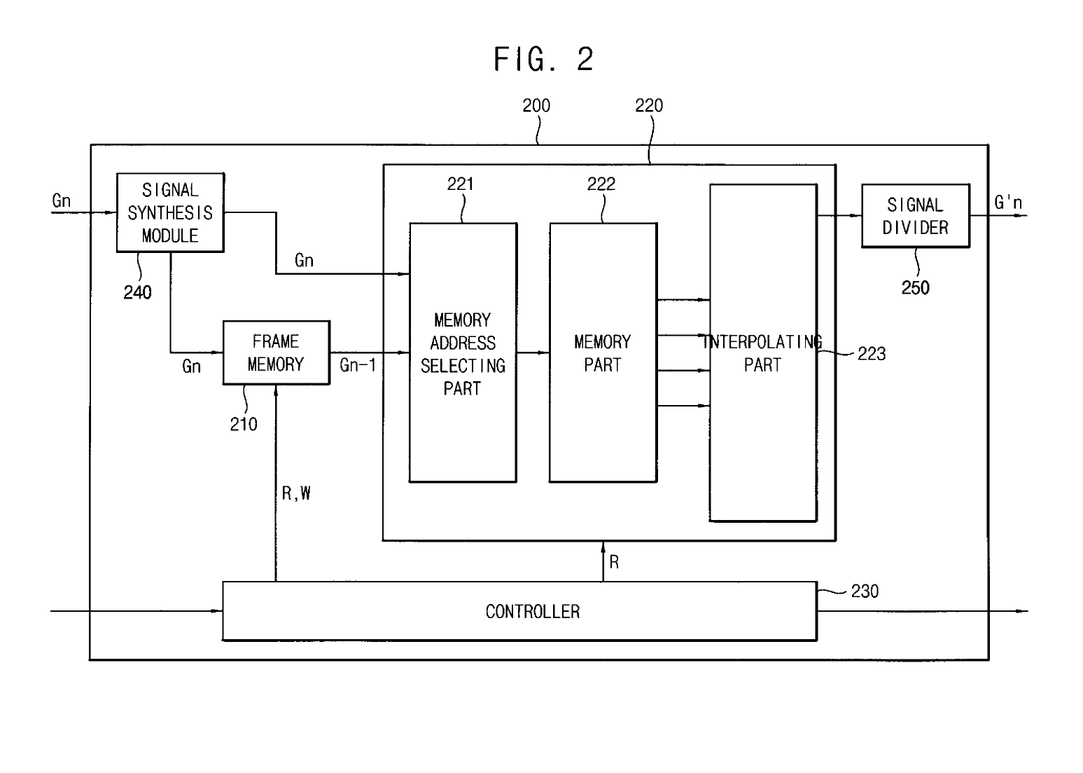

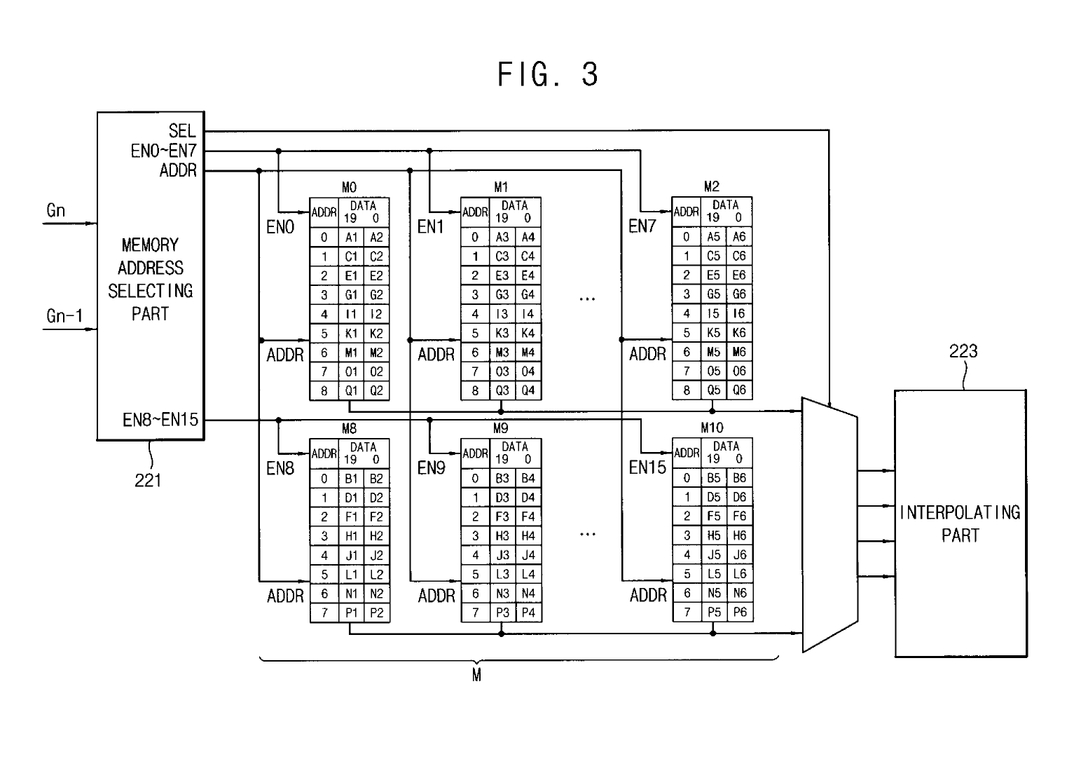

FIG. 2 is a block diagram of a grayscale data compensating part of display device 1000 of FIG. 1, according to an exemplary embodiment. FIG. 3 is a circuit diagram of the grayscale data converting part of FIG. 2.

As seen in FIGS. 2 and 3, the grayscale data compensating part 200 includes a frame memory 210, a grayscale data converting part 220, and a controller 230. It is contemplated, however, that grayscale data compensating part 200 may embody many forms and include multiple and/or alternative components or features.

The grayscale data compensating part 200 is configured to receive grayscale data Gn of a current frame from, for example, an external device. The grayscale data Gn may be provided to the frame memory 210 and the grayscale data converting part 220. According to certain exemplary embodiments, grayscale data Gn may undergo signal synthesis and/or one or more other signal processing techniques before being provided to frame memory 210 and/or grayscale data converting part 220, which is described in more detail below. In general, however, signal synthesis module 240 may, for example, be provided upstream from frame memory 210 and grayscale data converting part 220 to effectuate the aforementioned signal synthesis; however, one or more additional and/or other signal processing modules may be provided.

The frame memory 210 is configured to read (or otherwise determine) previously stored grayscale data Gn-1 of at least one previous frame in response to the controller 230, provide the previously stored grayscale data Gn-1 to the grayscale data converting part 220, and write (or otherwise store) the current grayscale data Gn of a current frame.

The grayscale data converting part 220 is configured to read (or otherwise receive) the current grayscale data Gn of a current frame and the previously stored grayscale data Gn-1 of a previous frame from the memory part 222 in response to the controller 230, and apply dynamic capacitance compensation (DCC) to the current grayscale data Gn based on the current grayscale data Gn and the previously stored grayscale data Gn-1 to generate compensated grayscale data G′n.

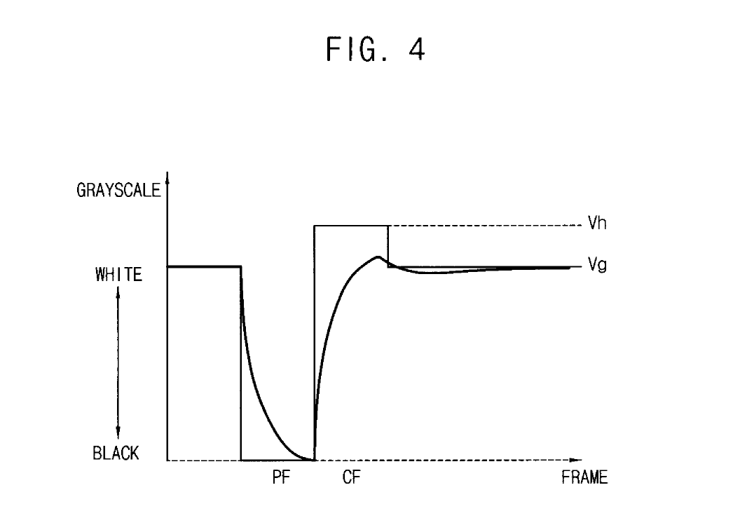

Adverting momentarily to FIG. 4, there is shown a graph illustrating the application of dynamic capacitance compensation (DCC) to the grayscale data, according to an exemplary embodiment.

As shown, a voltage Vh higher than a goal voltage Vg corresponding to current grayscale data of a current frame CF may be applied to one or more liquid crystal parts (not shown) of a liquid crystal layer associated with display panel 110, so that a response time with which the liquid crystal part(s) reaches the goal voltage Vg may be decreased.

The voltage Vh, which is higher than the goal voltage Vg, may be provided in consideration with previous grayscale data of at least one previous frame and current grayscale data of a current frame. As such, at least one previous frame may be a previous frame PF right before the current frame CF.

When, for example, the previous grayscale data is associated with display of a black image (or pixel) and the current grayscale data is associated with display of a white image (or pixel), a response time of the liquid crystal part(s) may increase. Thus, a response time associated with reaching the goal voltage Vg may be increased, such that an after image (or some other undesirable optical effect) may be generated.

Therefore, according to various exemplary embodiments, a new compensated grayscale data may be generated based on the previous grayscale data and the current grayscale data, so that the time associated with reaching the goal voltage Vg may be shorten based on the compensated grayscale data.

For example, when the previous grayscale data is associated with display of the black image (or pixel) and the current grayscale data is associated with display of the white image (or pixel), the voltage applied to the liquid crystal part(s), e.g., a pixel, may be overdriven to the higher voltage Vh based on the compensated grayscale data. As such, a higher quality image may be obtained.

With continued reference to FIGS. 2 and 3, the grayscale data converting part 220 includes, for instance, a memory address selecting part 221, a memory part 222, and an interpolating part 223. It is contemplated, however, that grayscale data compensating part 200 may embody many forms and include multiple and/or alternative components or features.

According to various exemplary embodiments, the memory part 222 includes a plurality of memories M. The plurality of memories M are configured to store at least one look-up table (LUT) consisting of, for instance, columns including the reference data corresponding to representative values of the grayscale data of the previous frame, respectively, and rows including the reference data corresponding to representative values of the grayscale data of the current frame, respectively. It is contemplated, however, that any suitable storage architecture may be utilized, such as any suitable relational, hierarchical, networked, inverted, object-referenced, unstructured, etc., structures. It is further contemplated that any number of memories may be provided, such that, in certain exemplary embodiments, some or all of the plurality of memories M may be divisions (or parts) of a same discrete memory unit. For instance, memories M1, M2, . . . , M6, and M7 may be logical divisions of a first discrete memory unit, whereas memories M8, M9, . . . , M14, and M15 may be logical divisions of a second discrete memory unit. As another example, each of the plurality of memories M may define a logical division of a discrete memory unit. In other words, any suitable number of memory units may be utilized to define the plurality of memories M.

In certain exemplary embodiments, a first group of memories (e.g., memories M1, M2, . . . , M6, and M7) of the plurality of memories M may be configured to store the reference data corresponding to an odd row of a LUT. For example, the first group memories M1, M2, . . . , M6, and M7 may be configured to store the reference data corresponding to an odd row and one or more column units including, for instance, at least two columns adjacent to each other in a LUT.

Accordingly, a second group of memories (e.g., memories M8, M9, . . . , M14, and M15) of the plurality of memories M may be configured to store the reference data corresponding to an even row of the LUT. For example, the second group memories M8, M9, . . . , M14, and M15 may be configured to store the reference data corresponding to an even row and one or more column units including, for instance, at least two columns adjacent to each other in the LUT.

The memory address selecting part 221 is configured to select at least some of the plurality of memories M based on the previous grayscale data, and select an address of at least some of the plurality of memories M based on the current grayscale data.

For example, the memory address selecting part 221 may select one memory, two memories, or four memories of the plurality of memories M based on the previous grayscale data. It is contemplated, however, that any suitable number of memories may be selected via memory address selecting part 221.

The memory part 222 is configured to output the reference data of one or more LUTs corresponding to the address of at least some of the plurality of memories M, that have been selected by the memory address selecting part 221.

The interpolating part 223 is configured to interpolate the reference data, and calculate compensated grayscale data based, at least, on the current grayscale data.

For example, when the memory address selecting part 221 selects two memories of the plurality of memories M based on the previous data, the interpolating part 223 may linearly interpolate the reference data of the LUT(s) corresponding to, for instance, the address of the two selected memories.

As another example, when the memory address selecting part 221 selects, for instance, four memories of the plurality of memories M based on the previous data, the interpolating part 223 may linearly interpolate the reference data of the LUT(s) corresponding to, for example, the address of the four selected memories. In other words, interpolation of the reference data by interpolating part 223 may be based on, and performed according to, the number of memories selected by memory address selecting part 221. It is contemplated, however, that direct one-to-one correspondence may not be necessary depending on, for instance, the storage architecture of the aforementioned data.

According to various exemplary embodiments, the grayscale data compensating part 200 may further include a signal synthesis module 240 and a signal divider 250.

The signal synthesis module 240 may be configured to receive grayscale data Gn of a current frame from, for example, an external device, and further configured to convert a frequency of the grayscale data Gn of the current frame into at least one other frequency compatible with the frame memory 210. The grayscale data Gn of the current frame converted (or otherwise modified) by the signal synthesis module 240 may be provided to the frame memory 210 and the grayscale data converting part 220.

The signal divider 250 may be configured to divide the compensated grayscale data G′n of the current frame and to output the compensated grayscale data G′n of the current frame to the data driving part 130.

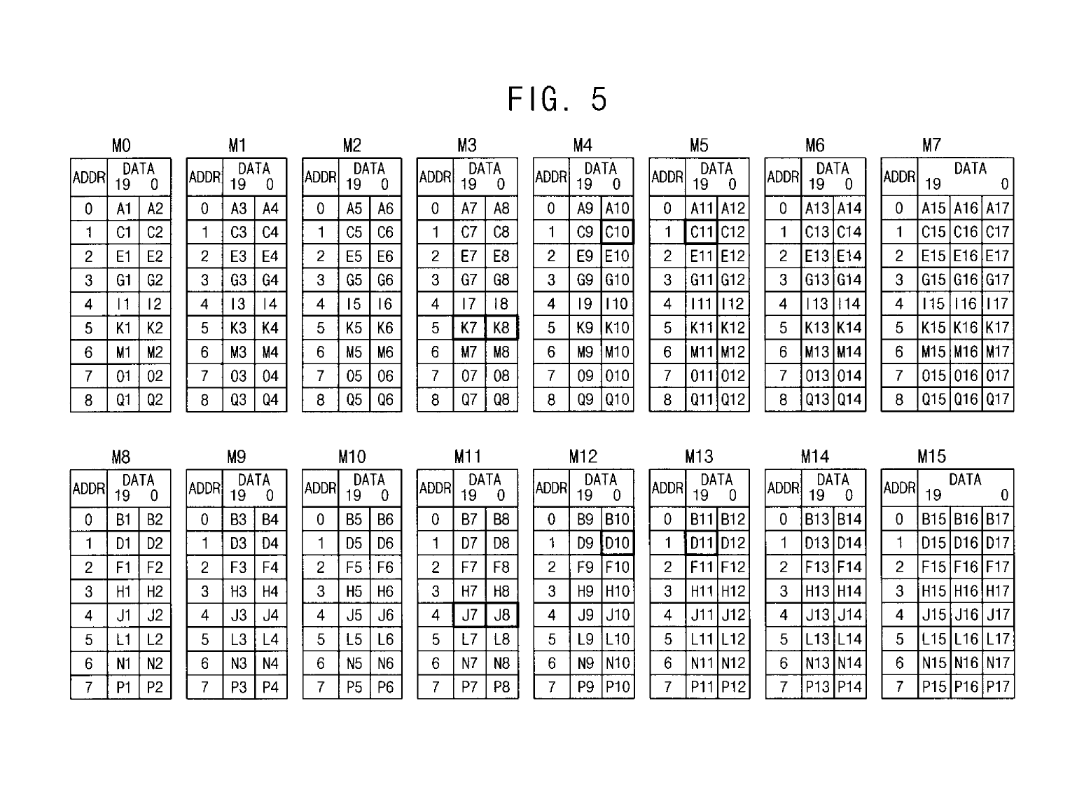

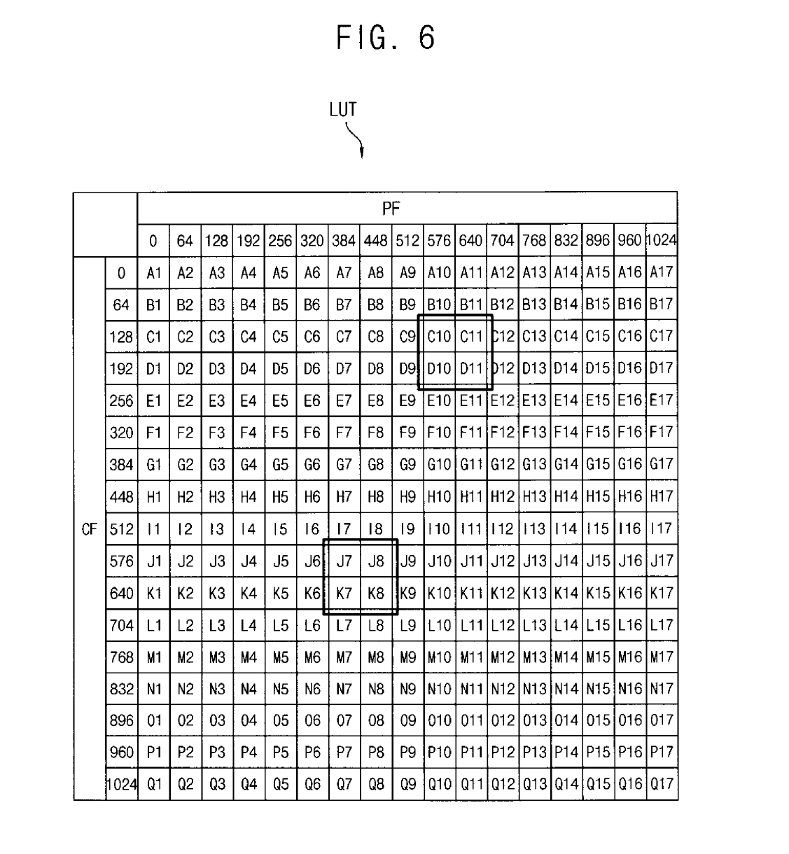

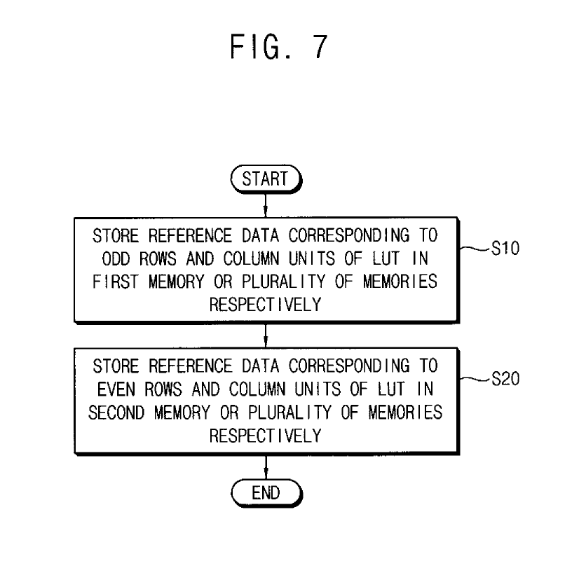

FIG. 5 is a view of various exemplary memories of FIG. 3. FIG. 6 is a LUT stored in association with the memories of FIG. 5, according to an exemplary embodiment. FIG. 7 is a flowchart of a process to store one or more LUTs in association with the memories, according to an exemplary embodiment.

With reference to FIGS. 5-7, the memory part 222 of the grayscale data converting part 220 may include first to sixteenth memories M0, M1, . . . , M14, and M15. The first to sixteenth memories M0, M1, . . . , M14, and M15 may embody the LUT illustrated and described in association with FIG. 6.

For example, when the display device 110 displays 10 bit (1024) grayscale data, the number of cases of combinations of the grayscale data of a previous frame PF and the grayscale data of a current frame CF may be 1,038,576.

It is difficult to store all the number of cases of combinations in the plurality of memories M, e.g., memories M0, M1, . . . , M14, and M15. Thus, the reference data corresponding to the representative values of the grayscale data of the previous frame and the reference data corresponding to the representative values of the grayscale data of the current frame may be stored in, for example, the first to sixteenth memories M0, M1, . . . , M14, and M15. The reference data corresponding to the representative values of the grayscale data of the previous frame and the reference data corresponding to the representative values of the grayscale data of the current frame may be interpolated, e.g., linearly, by the interpolating part 222 to find (or otherwise determine) the reference data corresponding to the remaining values except for the representative values of the grayscale data of the previous frame and remaining values except for the representative values of the grayscale data of the current frame.

An exemplary LUT may have a 17×17 matrix shape. In this manner, a horizontal axis of the LUT may be configured to indicate previous grayscale data Gn-1 of the previous frame PF, and a vertical axis of the LUT may be configured to indicate current grayscale data Gn of the current frame CF.

As such, columns of the LUT may indicate the reference data corresponding representative values of the grayscale data of the previous frame PF (or representative compensated grayscale data corresponding representative values of the grayscale data of the previous frame PF), and rows of the LUT may indicate the reference data corresponding to representative values of the grayscale data of the current frame CF (or representative compensated grayscale data corresponding representative values of the grayscale data of the current frame CF).

The reference data corresponding to odd rows and column units including, for instance, at least two columns adjacent to each other in the LUT may be stored in the first to eighth memories M0, M1, . . . , M6, and M7, respectively (step S10).

For example, the first memory M0 may store the reference data corresponding to the first odd row and the first and second columns of the LUT, the second memory M1 may store the reference data corresponding to the second odd row and the third and fourth columns of the LUT, the third memory M2 may store the reference data corresponding to the third odd row and the fifth and sixth columns of the LUT, the fourth memory M3 may store the reference data corresponding to the fourth odd row and the seventh and eighth columns of the LUT, the fifth memory M4 may store the reference data corresponding to the fifth odd row and the ninth and tenth columns of the LUT, the sixth memory M5 may store the reference data corresponding to the sixth odd row and the eleventh and twelfth columns of the LUT, the seventh memory M6 may store the reference data corresponding to the seventh odd row and the thirteenth and fourteenth columns of the LUT, and the eighth memory M7 may store the reference data corresponding to the eighth odd row and the fifteenth, sixteenth, and seventeenth columns of the LUT.

The reference data corresponding to even rows and the column units including, for example, at least two columns adjacent to each other in the LUT may be stored in the ninth to sixteenth memories M8, M9, . . . , M14, and M15, respectively (step S20).

In association with the previous example, the ninth memory M8 may store the reference data corresponding to the first even row and the first and second columns of the LUT, the tenth memory M9 may store the reference data corresponding to the second even row and the third and fourth columns of the LUT, the eleventh memory M10 may store the reference data corresponding to the third even row and the fifth and sixth columns of the LUT, the twelfth memory M11 may store the reference data corresponding to the fourth even row and the seventh and eighth columns of the LUT, the thirteenth memory M12 may store the reference data corresponding to the fifth even row and the ninth and tenth columns of the LUT, the fourteenth memory M13 may store the reference data corresponding to the sixth even row and the eleventh and twelfth columns of the LUT, the fifteenth memory M14 may store the reference data corresponding to the seventh even row and the thirteenth and fourteenth columns of the LUT, and the sixteenth memory M15 may store the reference data corresponding to the eighth even row and the fifteenth, sixteenth and seventeenth columns of the LUT.

It is contemplated, however, that the rows and columns of data associated with the LUT may be alternatively stored in association with the plurality of memories M.

Accordingly, utilization of at least one address of a part of the first to sixteenth memories M0, M1, . . . , M14, and M15 for selection based on the previous grayscale data of the previous frame PF and the current grayscale data of the current frame CF so that the reference data of the current frame CF may be output is described in more detail in association with FIGS. 5, 6, and 8-10.

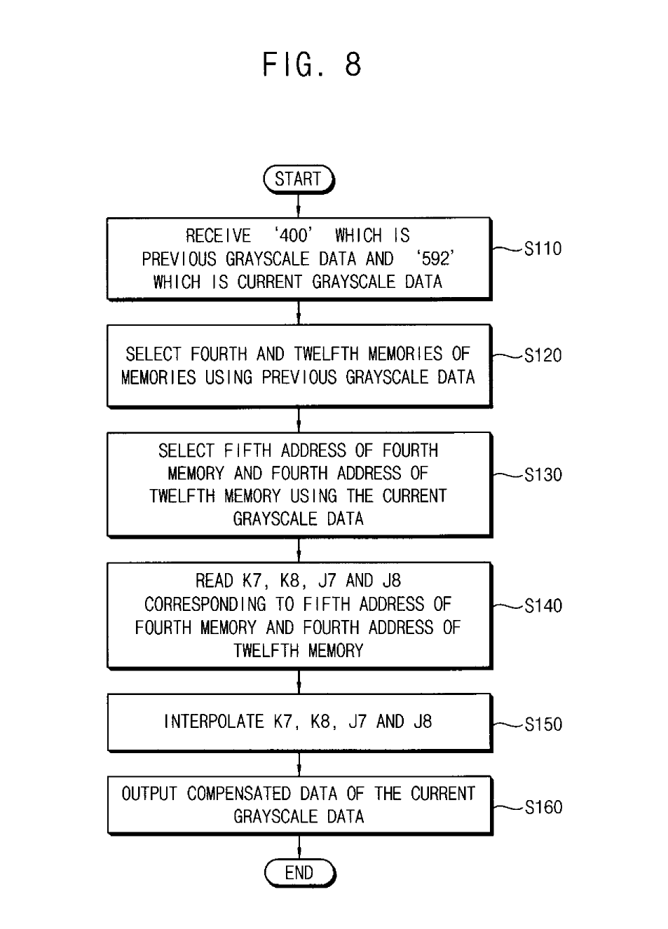

FIG. 8 is a flowchart of a process to compensate grayscale data, according to an exemplary embodiment.

With reference to FIGS. 5, 6, and 8, it is noted that ‘400’ corresponds to the previous grayscale data value, and ‘592’ corresponds to the current grayscale data value.

Accordingly, the grayscale data converting part 220 may receive ‘400’ which is the previous grayscale data value and ‘592’ which is the current grayscale data value (step S110).

In the LUT, the reference data J7, J8, K7 and K8 may, for example, be output, which corresponds to a seventh column having 384 grayscale of the previous frame PF and an eighth column having 448 grayscale of the previous frame PF, which the ‘400’ value is between, and a tenth row having 576 grayscale of the current frame CF and an eleventh row having 592 grayscale of the current frame CF, which the ‘592’ value is between.

As such, the memory address selecting part 221 of the grayscale data converting part 220 may select the fourth and twelfth memories M3 and M11, which store the seventh and eighth columns of the LUT, from the first to sixteenth memories M0, M1, . . . , M14, and M15 based on the previous grayscale data (step S120). The memory address selecting part 221 may select a fourth address storing the tenth row of the LUT of the twelfth memory M11 and a fifth address storing the eleventh row of the LUT of the fourth memory M3 based on the current grayscale data (step S130).

In this manner, the fourth memory M3 may output the reference data (for example, K7 and K8) of the fifth address, and the twelfth memory M11 may output the reference data (for example, J7 and J8) of the fourth address (step S140).

The reference data K7, K8, J7, and J8 may be read (or otherwise retrieved) simultaneously.

The interpolating part 223 of the grayscale data converting part 220 may apply two-dimensional linear interpolation based on the reference data K7, K8, J7, and K8 (step S150) to output compensated data of the current grayscale data (step S160).

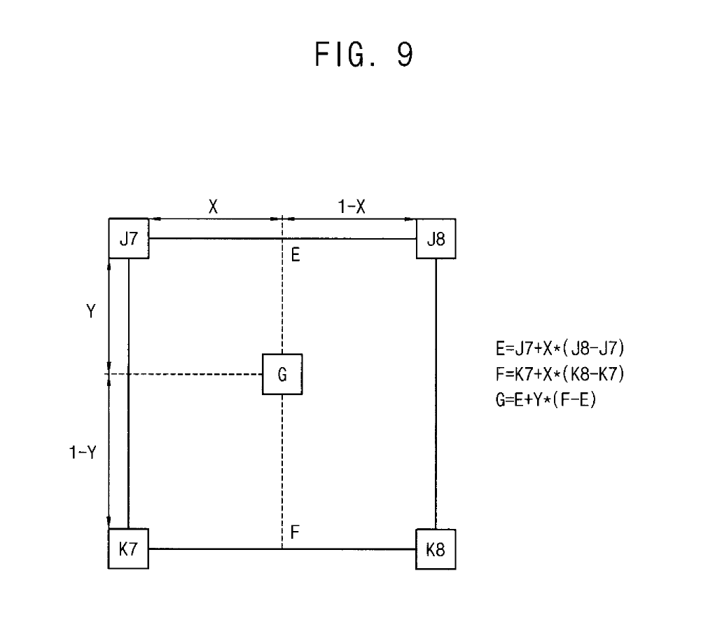

FIG. 9 schematically illustrates a process to facilitate interpolation of grayscale data, according to an exemplary embodiment.

With continued reference to FIG. 8, the interpolating part 223 may apply two-dimensional linear interpolation based on the reference data J7, J8, K7, and K8 output from the fourth and twelfth memories M3 and M11 to generate (or otherwise determine) compensated data of the current grayscale data.

For example, the interpolating part 223 may calculate (or otherwise determine) a first interpolation value E between J7 and J8 based on J7 and J8 of the reference data, calculate a second interpolation value F between K7 and K8 based on K7 and K8 of the reference data, and generate the compensated data G of the current grayscale data based on the first interpolation value E and the second interpolation value F.

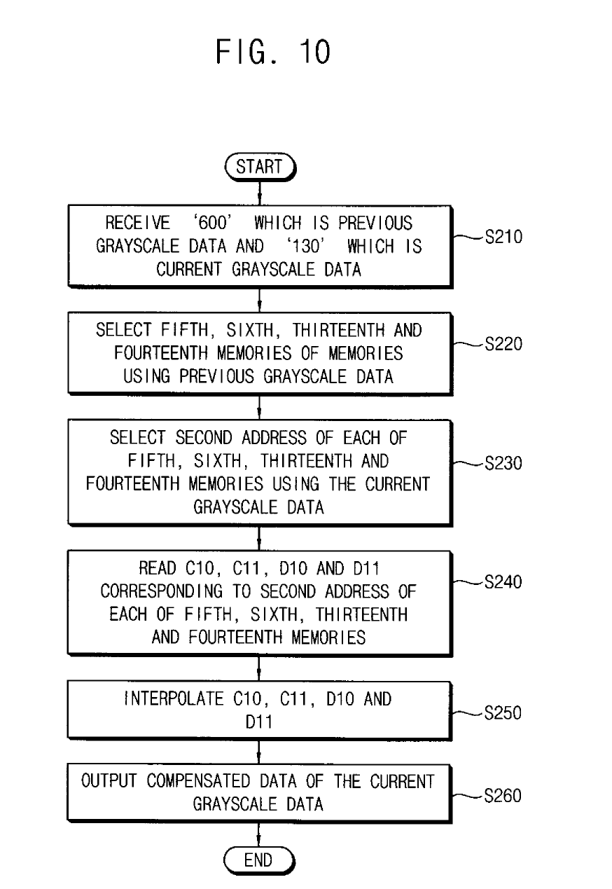

FIG. 10 is a flowchart of a process to compensate grayscale data, according to another exemplary embodiment.

With reference to FIGS. 5, 6, and 10, it is noted that ‘600’ corresponds to the previous grayscale data value, and ‘130’ corresponds to the current grayscale data value.

Accordingly, the grayscale data converting part 220 may receive ‘600’ which is the previous grayscale data value and ‘130’ which is the current grayscale data value (step S210).

In the LUT, the reference data C10, C11, D10, D11 may, for example, be output, which corresponds to a tenth column having 576 grayscale of the previous frame PF and an eleventh column having 640 grayscale of the previous frame PF, which the ‘600’ value is between, and a third row having 128 grayscale of the current frame CF and a fourth row having 192 grayscale of the current frame CF, which the ‘130’ value is between.

As such, the memory address selecting part 221 of the grayscale data converting part 220 may select the fifth, sixth, thirteenth and fourteenth memories M4, M5, M12, and M13 of the first to sixteenth memories M0, M1, . . . , M14, and M15 based on the previous grayscale data (step S220). The fifth, sixth, thirteenth, and fourteenth memories M4, M5, M12 and M13 store the tenth and eleventh columns of the LUT. The memory address selecting part 221 may select a second address of each of the fifth, sixth, thirteenth, and fourteenth memories M4, M5, M12 and M13 based on the current grayscale data (step S230). It is noted that the second address of the fifth memory M4 stores the third row of the LUT, the second address of the sixth memory M5 stores the third row of the LUT, the second address of the thirteen memory M12 stores the fourth row of the LUT, and the second address of the fourteen memory M13 stores the fourth row of the LUT.

In this manner, the fifth memory M4 may output the reference data (for example, C9 and C10) of the second address thereof, the sixth memory M5 may output the reference data (for example, C11 and C12) of the second address thereof. Further, the thirteen memory M12 may output the reference data (for example, D9 and D10) of the second address thereof, and the fourth memory M13 may output the reference data (for example, D11 and D12) of the second address thereof (step S240).

According to this exemplary embodiment, the upper 10 bits of each of the fifth and thirteenth memories M4 and M12 are disregarded, and the lower 10 bits of each of the sixth and fourteenth memories M5 and M13 are disregarded so that the final reference data C10, C11, D10 and D11 may be obtained.

The reference data C10, C11, D10, and D11 may be read (or otherwise retrieved) simultaneously.

The interpolating part 223 of the grayscale data converting part 220 may apply two-dimension linear interpolation based on the reference data C10, C11, D10 and D11 (step S250) to output compensated data of the current grayscale data (step S260).

In this manner, it is noted that interpolation of the reference data is substantially the same as described in association with FIG. 8 and, therefore, a corresponding description is omitted for the sake of brevity and to prevent unnecessarily obscuring various exemplary embodiments.

While various exemplary embodiments have been described in association with display devices configured to present (or otherwise display) in 10bit (1024) grayscales, it is contemplated that the various exemplary embodiments are not limited thereto. Namely, any suitable detail of grayscale imaging may be utilized and, as such, corresponding numbers of memories (or divisions thereof) may be provided therewith.

While various exemplary embodiments have been described such that a horizontal axis of the LUT corresponds to the previous grayscale data, and a vertical axis of the LUT corresponds to the current grayscale data, it is contemplated that the relationship may be reversed, or otherwise provided.

It is further contemplated that, while various exemplary embodiments have been described such that the number of memories M0, M1, . . . , M14, and M15 is 16, the number of memories may be modified based on, for instance, the number of columns and rows associated with the LUT or based on one or more other criteria.

According to various exemplary embodiments, the memory part 222 includes a first group of memories configured to store the reference data corresponding to the odd rows and the column units including at least two columns adjacent to each other in the LUT and a second group of memories configured to store the reference data corresponding to the even rows and the column units including at least two columns adjacent to each other in the LUT, so that the reference data may be prevented from being stored redundantly.

According to various exemplary embodiments, a display device includes a first plurality of memories configured to store reference data corresponding to a plurality of odd rows of a LUT, and a second plurality of memories configured to store reference data corresponding to a plurality of even rows of the LUT, so that the reference data may be prevented from being stored redundantly.

In addition, the display device includes the first plurality of memories being configured to store the reference data corresponding to the plurality of odd rows, such that each odd row is respectively associated with at least two columns of reference data adjacent to each other in the LUT, and the second plurality of memories being configured to store the reference data corresponding to the plurality of even rows, such that each even row is respectively associated with at least two columns of reference data adjacent to each other in the LUT, so that the reference data may be prevented from being stored redundantly.

Thus, the various memories may be optimized, and an entire size of the memory part may be reduced.

It will be apparent to those skilled in the art that various modifications and variations can be made without departing from the spirit or scope of the invention. Thus, it is intended that the present invention cover the modifications and variations provided they come within the scope of the appended claims and their equivalents.

What is claimed is:

1. A method, comprising:
storing, in a first plurality of memories via a processor, reference data corresponding to an odd row of a look-up table (LUT) based on one or more grayscale values associated with a current frame and one or more grayscale values associated with a previous frame; and
storing, in a second plurality of memories via the processor, reference data corresponding to an even row of the LUT based on the one or more grayscale values associated with the current frame and the one or more grayscale values associated with the previous frame.

2. The method of claim 1, wherein the odd row is associated with a first plurality of column units, each of the first plurality of column units comprising at least two adjacent values of the odd row, and wherein the even row is associated with a second plurality of column units, each of the second plurality of column units comprising at least two adjacent values of the even row, and wherein storing the reference data corresponding to the odd and even rows comprises:
storing, in each of the first plurality of memories, respectively, reference data corresponding to at least one of the first plurality of column units; and
storing, in each of the second plurality of memories, respectively, reference data corresponding to at least one of the second plurality of column units.

3. A method, comprising:
determining, via a first processor, an address of corresponding portions of a first group of memories and a second group of memories based on current grayscale data associated with a current frame and previous grayscale data associated with a previous frame, the first group of memories comprising reference data corresponding to an odd row of a look-up table (LUT) associated with the current grayscale data and the previous grayscale data, the second group of memories comprising reference data corresponding to an even row of the LUT associated with the current grayscale data and the previous grayscale data; and
compensating, via the first or a second processor, the current grayscale data using the reference data associated with the address of the corresponding portions of the first group of memories and the second group of memories.

4. The method of claim 3, wherein the first group of memories further comprise reference data corresponding to a first plurality of column units, each of the first plurality of column units comprising at least two adjacent values of the odd row, and wherein the second group of memories further comprise reference data corresponding to a second plurality of column units, each of the second plurality of column units comprising at least two adjacent values of the even row.

5. The method of claim 3, wherein a horizontal axis of the LUT is associated with the previous grayscale data, and a vertical axis of the LUT is associated with the current grayscale data.

6. The method of claim 5, wherein determining the address of the corresponding portions of the first and second group of memories comprises:
determining the corresponding portions of the first and second groups of memories using the previous grayscale data; and
determining the address of the corresponding portions of the first and second groups of memories using the current grayscale data.

7. The method of claim 3, wherein a horizontal axis of the LUT is associated with the current grayscale data, and a vertical axis of the LUT is associated with the previous grayscale data.

8. The method of claim 7, wherein determining the address of the corresponding portions of the first and second groups of memories comprises:
determining the corresponding portions of the first and second groups of memories using the current grayscale data; and
determining the address of the corresponding portions of the first and second groups of memories using the previous grayscale data.

9. The method of claim 3, wherein compensating the current grayscale data comprises:
interpolating, linearly, reference data corresponding to the address of the corresponding portions of the first and second groups of memories to generate compensated data of the current grayscale data.

10. The method of claim 9, further comprising:
receiving the previous grayscale data and the current grayscale data; and
outputting the compensated data.

11. A display device, comprising:
a grayscale data compensating part, comprising:
a grayscale data converting part,
a first group of memories configured to store reference data corresponding to an odd row of a look-up table (LUT) based on one or more current grayscale values associated with a current frame and one or more previous grayscale values associated with a previous frame, and
a second group of memories configured to store reference data corresponding to an even row of the LUT based one or more current grayscale values associated with the current frame and one or more previous grayscale values associated with the previous frame; and
a display panel configured to display an image in response to compensated grayscale data output from the grayscale data compensating part based on at least some of the reference data respectively stored in the first and second groups of memories.

12. The display device of claim 11, wherein the first group of memories is further configured to store reference data corresponding to a first plurality of column units, each of the first plurality of column units comprising at least two adjacent values of the odd row, and the second group of memories is further configured to store reference data corresponding to a second plurality of column units, each of the second plurality of column units comprising at least two adjacent values of the even row.

13. The display device of claim 11, wherein the grayscale data converting part comprises:
a memory address selecting part configured to determine an address of corresponding portions of the first and second groups of memories based on previous grayscale data associated with the previous frame and current grayscale data associated with the current frame; and
an interpolating part configured to interpolate reference data corresponding to the address of the corresponding portions of the first and second groups of memories.

14. The display device of claim 13, wherein a horizontal axis of the LUT is associated with the previous grayscale data, and a vertical axis of the LUT is associated with the current grayscale data.

15. The display device of claim 14, wherein the memory address selecting part is further configured to determine the corresponding portions of the first and second groups of memories using the previous grayscale data, and determine the address of the corresponding portions of the first and second groups of memories using the current grayscale data.

16. The display device of claim 13, wherein a horizontal axis of the LUT is associated with the current grayscale data, and a vertical axis of the LUT is associated with the previous grayscale data.

17. The display device of claim 16, wherein the memory address selecting part is further configured to determine the corresponding portions of the first and second groups of memories using the current grayscale data, and determine the address of the corresponding portions of the first and second groups of memories using the previous grayscale data.

18. The display device of claim 11, wherein the grayscale data compensating part further comprises a frame memory configured to:
store the previous grayscale data; and
output the previous grayscale data in response to the current grayscale data.

19. The method of claim 2, wherein respective positions associated with the first plurality of column units correspond to respective positions associated with the second plurality of column units.

20. The method of claim 4, wherein respective positions associated with the first plurality of column units correspond to respective positions associated with the second plurality of column units.

21. The display device of claim 12, wherein respective positions associated with the first plurality of column units correspond to respective positions associated with the second plurality of column units.

22. The method of claim 1, wherein the first plurality of memories and the second plurality of memories comprise a plurality of corresponding discrete memory units or corresponding logical divisions of one or more discrete memory units.

23. The method of claim 3, wherein the first group of memories and the second group of memories comprise a plurality of corresponding discrete memory units or corresponding logical divisions of one or more discrete memory units.

24. The display device of claim 11, wherein the first group of memories and the second group of memories comprise a plurality of corresponding discrete memory units or corresponding logical divisions of one or more discrete memory units.
